(19) United States
(12) Patent Application Publication
(10) Pub. No.: US 2026/0353171 A1
(43) Pub. Date: Nov. 5, 2026

(54) SYSTEM AND METHOD FOR INTELLIGENT TRAFFIC STEERING IN RADIO ACCESS TECHNOLOGIES (RAT)

(71) Applicant: Telefonaktiebolaget LM Ericsson (publ), Stockholm (SE)

(72) Inventors: Medhat ELSAYED, Nepean (CA); Md Arafat HABIB, Gatineau (CA); Hao ZHOU, Ottawa (CA); Pedro Enrique ITURRIA RIVERA, Ottawa (CA); Melike EROL-KANTARCI, Ottawa (CA); Majid BAVAND, Ottawa (CA); Raimundas GAIGALAS, Hãsselby (SE); Yigit OZCAN, Gloucester (CA)

(73) Assignee: Telefonaktiebolaget LM Ericsson (publ), Stockholm (SE)

(21) Appl. No.: 19/120,218

(22) PCT Filed: Nov. 9, 2023
(86) PCT No.: PCT/IB2023/061346

§ 371 Date: Apr. 10, 2025

Related U.S. Application Data
(60) Provisional application No. 63/423,882, filed on Nov. 9, 2022.

(51) Int. Cl. H04W 28/02; H04W 28/08

(52) U.S. Cl. CPC H04W 28/0268; H04W 28/08

(57) ABSTRACT

A method and Open Radio Access Network (O-RAN) node for intelligent traffic steering in radio access technology (RATs) are disclosed. According to one aspect, a method in an O-RAN node includes performing a hierarchical reinforced learning (HRL) process configured to steer traffic between network nodes and wireless devices (WDs) using different radio access technologies (RATs) according to a traffic type and a link quality subject to constraints on delay and throughput.

### TECHNICAL FIELD

The present disclosure relates to wireless communications, and in particular, to systems and methods for intelligent traffic steering in a radio access technology (RAT).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

The complex environment of fifth-generation 5G NR becomes more challenging in non-standalone (NSA) mode since it includes long-term evolution (LTE) networks, too. This results in multiple radio access technologies (multi-RAT) with dual connectivity (DC). Each type of RAT has different abilities to provide service to the user equipment (UE), (hereinafter referred to as a wireless device (WD)), having diverse quality of service (QoS) requirements. However, if user traffic is steered to the same base station, (hereinafter referred to as a network node), with a certain RAT that may best serve the QoS requirements, it may result in unbalanced load distribution. This will eventually cause a high delay in the network leading to packet drops and may have a negative impact on the average system throughput. If traffic with a high load arrives and data packets are aggregated into a flow, they cannot be segregated again. Therefore, if a packet is forwarded to a congested queue, it will suffer from a long waiting time until the queue is emptied. Considering all these issues, it becomes challenging to develop a load-aware robust traffic steering scheme.

New throughput-hungry applications that emerged after the appearance of 5G have reached an unprecedented level. These applications require stringent fulfillment of QoS demands along with flexible and intelligent network management entities. Furthermore, architectural reformation introduced in the open radio access network (O-RAN) may facilitate a RAN with openness and required intelligence. The radio controller in an O-RAN architecture is divided into two parts: near-real-time RAN intelligent controller (near-RT-RIC), and non-real-time RAN intelligent controller (non-RT-RIC). The non-RT-RIC is at the top of the hierarchy that serves as a software platform for the designed rApp for high-level RAN optimization. It has visibility into network information and provides artificial intelligence (AI)-based feeds and recommendations to a near-RT-RIC. The near-RT-RIC in the lower level enables control and optimization of RAN elements. The programmable and highly modular structure of O-RAN is quite suitable for developing advanced AI-based modules to perform network optimization via robust traffic steering schemes.

A machine learning (ML)-enabled traffic steering scheme is a tool to optimize network performance in a multi-RAT environment. Considering this fact, attempts have been made to design traffic steering schemes for 5G infrastructure using ML, especially reinforcement learning (RL). RL algorithms may avoid having to implement a dedicated optimization model since optimization problems may be transformed into Markov decision processes (MDPs). Compared to conventional RL algorithms, hierarchical reinforcement learning (HRL) may provide better exploration efficiency via a meta-controller and a controller instead of using a standalone agent. In particular, the bi-level architecture of O-RAN having near and non-RT-RIC makes it a suitable candidate to embed the meta-controller and controller in the O-RAN hierarchy as rApps and xApps.

Previous works do not consider HRL for traffic steering schemes, and the typical reinforcement learning algorithms cannot handle complicated network environments with many network parameters in the O-RAN hierarchy.

Many of the existing works ignore the diverse QoS requirements of multiple traffic types for different users in the network. This causes issues in user experience.

Crucial network information like load status is ignored while designing traffic steering algorithms in the existing works.

Intelligent traffic steering schemes would always steer traffic to the base station (network node) that best serves the QoS requirements of a traffic type. However, repeatedly doing so would increase the load significantly to a network node that will require load balancing. This issue has been ignored in the existing works.

### SUMMARY

Some embodiments advantageously provide methods and devices for intelligent traffic steering in a radio access technology (RAT).

Some embodiments maintain QoS requirements of all the traffic types simultaneously via a hierarchical reinforcement learning (HRL)-based traffic steering scheme that, at the same time, is able to perform threshold-based load balancing in an O-RAN environment. The threshold is associated with the queue length of each RAT which is provided by the meta-controller, and the controller in the lower level is responsible for RAT-specific traffic steering.

Application of HRL for traffic steering in a multi-RAT environment that may support multiple types of data traffic and their QoS requirements are disclosed. In some embodiments, threshold-based load balancing is performed in an O-RAN architecture in non-RT-RIC. Some embodiments provide an automated advanced AI-based traffic steering that has not been addressed in the previous works. Some embodiments, provide an HRL-based traffic steering mechanism that supports the multi-RAT environment. Some embodiments provide support for users having multiple traffic types and dynamic QoS requirements. Some embodiments provide a load-based traffic steering process that inherently leads to load balancing in the network via the bi-level hierarchy of HRL. Some embodiments provide O-RAN integration of the work where load-balancing thresholds are learned by the near-RT-RIC and the optimal traffic steering decisions are taken by the near-RT-RIC in two different time scales. Some embodiments provide HRL-based traffic steering that outperforms a Deep Q-Learning (DQN) and a threshold-based heuristic baseline with 8.49%, 12.52% higher average system throughput and 27.74%, 39.13% lower network delay, respectively. It also guarantees faster convergence compared to the typical RL-based algorithms.

According to one aspect, an Open Radio Access Network, O-RAN, node configured to communicate with a plurality of network nodes and wireless devices (WDs) is provided. The O-RAN node is configured to perform a hierarchical reinforced learning, HRL, process configured to steer traffic between network nodes and WDs using different radio access technologies, RATs, subject to constraints on delay and throughput.

According to this aspect, in some embodiments, performing the HRL process includes implementing a meta-controller to determine goals and implementing a controller to determine actions to achieve the goals, the goals including a specified throughput and delay for the steered traffic. In some embodiments, the controller is configured to obtain an intrinsic reward based at least in part on an actual throughput and delay of the steered traffic. In some embodiments, a goal of the controller is a threshold associated with a queue length of each type of RAT. In some embodiments, states of the controller depend on at least one of a traffic type, a link quality between a network node and a WD and a queue length. In some embodiments, the meta-controller is configured to obtain an extrinsic reward based at least in part on a sum of intrinsic rewards. In some embodiments, states of the meta-controller depend on at least one of a traffic type, a signal to interference plus noise ratio, SINR, measurement a queue length. In some embodiments, the meta-controller is configured to generate a policy based at least in part on states of the meta-controller. In some embodiments, the controller is configured to generate a policy based at least in part on a state of the meta-controller. In some embodiments, performing the HRL process includes steering the traffic based at least in part on a comparison of a load balancing metric to a threshold.

According to another aspect, a method in an O-RAN node configured to communicate with a plurality of network nodes and wireless devices (WDs) is provided. The method includes performing a hierarchical reinforced learning, HRL, process configured to steer traffic between network nodes and WDs using different radio access technologies, RATs, subject to constraints on delay and throughput.

According to this aspect, in some embodiments, performing the HRL process includes implementing a meta-controller to determine goals and implementing a controller to determine actions to achieve the goals, the goals including a specified throughput and delay for the steered traffic. In some embodiments, implementing the controller includes obtaining an intrinsic reward based at least in part on an actual throughput and delay of the steered traffic. In some embodiments, a goal of the controller is a threshold associated with a queue length of each type of RAT. In some embodiments, states of the controller depend on at least one of a traffic type, a link quality between a network node and a WD and a queue length. In some embodiments, implementing the meta-controller includes obtaining an extrinsic reward based at least in part on a sum of intrinsic rewards. In some embodiments, states of the meta-controller depend on at least one of a traffic type, a signal to interference plus noise ratio, SINR, measurement a queue length. In some embodiments, implementing the meta-controller includes generating a policy based at least in part on states of the meta-controller. In some embodiments, implementing the controller includes generating a policy based at least in part on a state of the meta-controller. In some embodiments, performing the HRL process includes steering the traffic based at least in part on a comparison of a load balancing metric to a threshold.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for systems and methods for intelligent traffic steering in a radio access technology (RAT);

FIG. 8 is a flowchart of another example process in a network node for systems and methods for intelligent traffic steering in a radio access technology (RAT);

FIG. 9 is an O-RAN based network architecture with a multi-RAT network environment according to principles set forth herein;

FIG. 10 is an HRL architecture according to principles disclosed herein;

FIG. 11 is a flowchart of an example process according to principles disclosed herein; and

FIG. 12 is an O-RAN schematic diagram according to principles disclosed herein.

### DETAILED DESCRIPTION

Before describing in detail example embodiments, it is noted that the embodiments reside primarily in combinations of apparatus components and processing steps related to systems and methods for intelligent traffic steering in a radio access technology (RAT). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (network node), radio base station, base transceiver station (BTS), base station controller (network node), radio network controller (RNC), g Node B (gNB), evolved Node B (eNB or eNodeB), Node B, multi-standard radio (MSR) radio node such as MSR network node, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide systems and methods for intelligent traffic steering in a radio access technology (RAT).

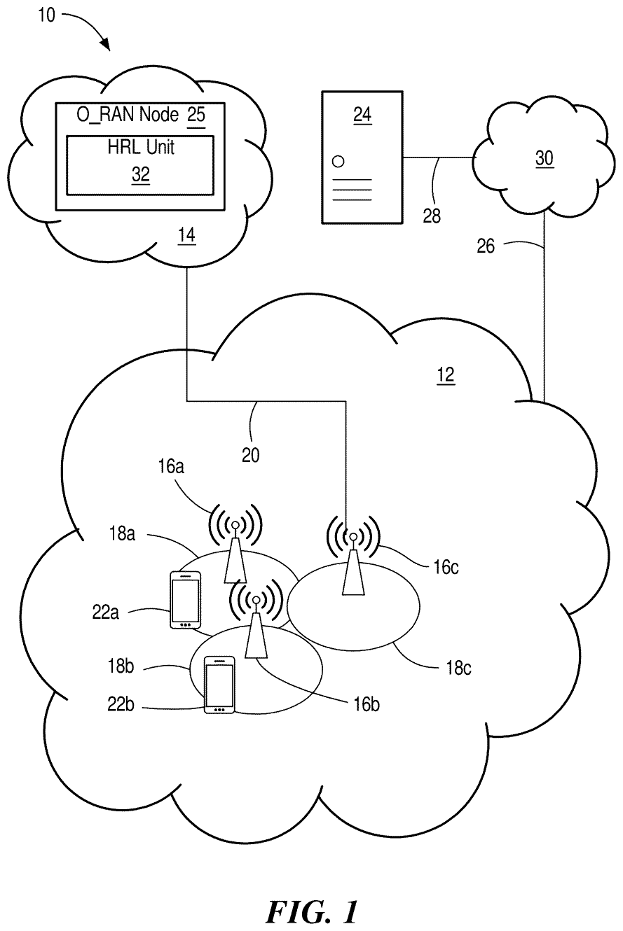

Referring now to the drawing figures, in which like elements are referred to by like reference numerals, there is shown in FIG. 1 a schematic diagram of a communication system 10, according to an embodiment, such as an O-RAN and/or 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The core network 14 includes an O-RAN node 25 which is configured to perform a hierarchical reinforced learning (HRL) process implemented by an HRL unit 32 in order to steer traffic among the network nodes 16 and WDs 22. The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

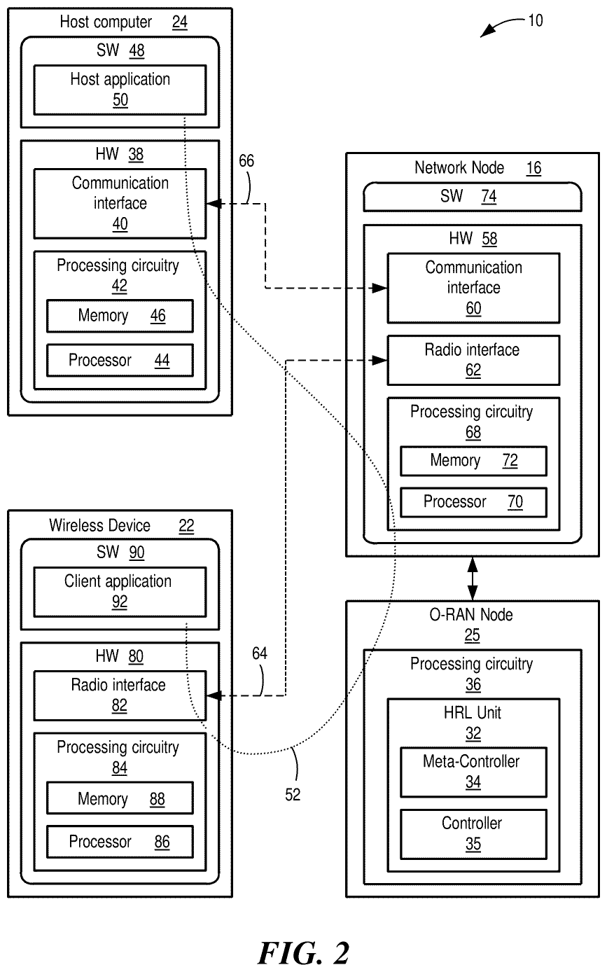

Example implementations, in accordance with an embodiment, of the WD 22, network node 16, host computer 24 and the O-RAN node 25 will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes the O-RAN node 25 which includes the HRL unit 32. The HRL unit 32 is configured to perform a hierarchical reinforced learning (HRL) process to steer traffic between network nodes 16 and WDs 22 using different radio access technologies (RATs) according to a traffic type and a link quality subject to constraints on delay and throughput. Some or all of the functions of the HRL unit 32 may be distributed between the O-RAN node 25 and a network node 16. The HRL unit 32 includes a meta-controller 34 and a controller 35. The meta-controller 34 is configured to observe a network of network nodes 16 and to define goals. The controller 34 is configured to determine actions to be performed by network nodes 16 in order to, for example, steer traffic between network nodes 16 and WDs 22 to achieve load balancing. The HRL unit 32 may be implemented by processing circuitry 36 which may include a processor and a memory. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. As noted, the processing circuitry 36 may include a processor that may be configured to access (e.g., write to and/or read from) a memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

The communication system 10 further includes the network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as HRL unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

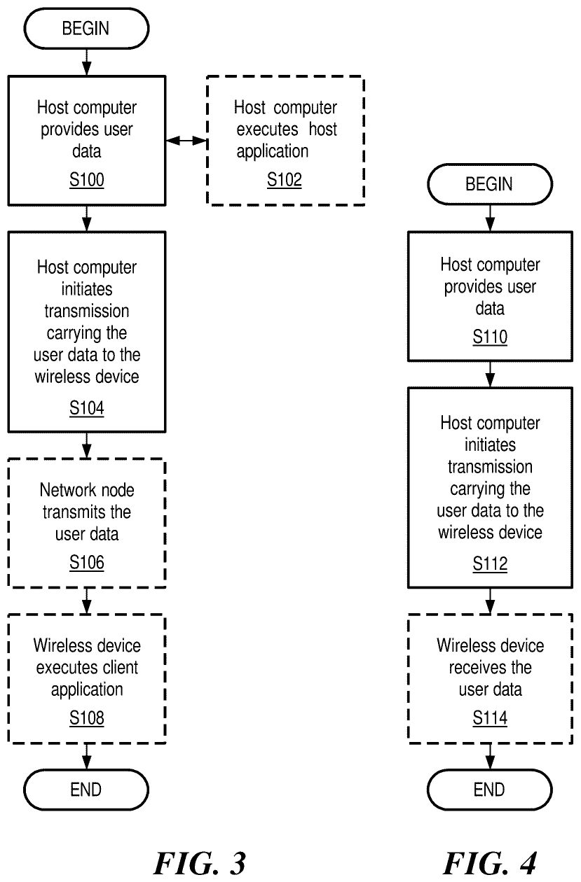

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

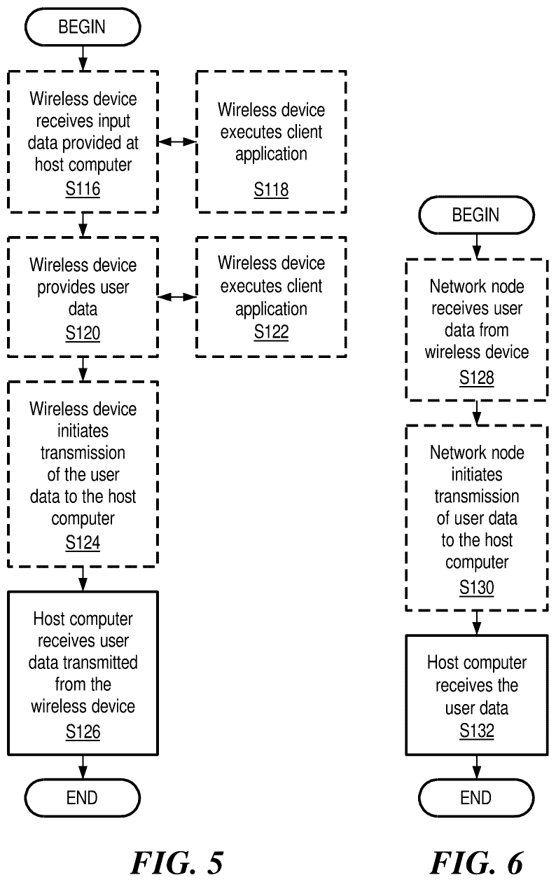

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

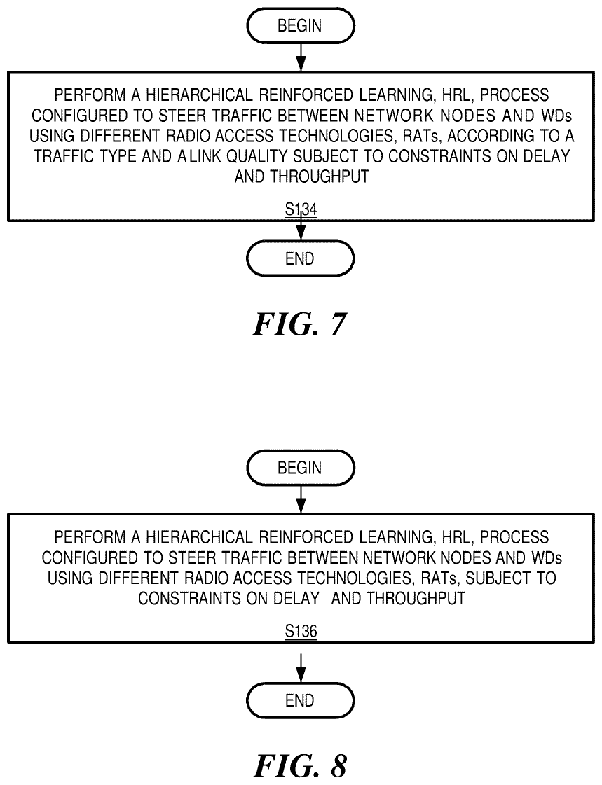

FIG. 7 is a flowchart of an example process in an O-RAN node 25 for intelligent traffic steering in a radio access technology (RAT). One or more blocks described herein may be performed by one or more elements of O-RAN node 25 such as by processing circuitry 36 (including the HRL unit 32). The O-RAN node 25 such as via processing circuitry 36 is configured to perform a hierarchical reinforced learning, HRL, process configured to steer traffic between WDs 22 using different radio access technologies, RATs, according to a traffic type and a link quality subject to constraints on delay and throughput (Block S134).

In some embodiments, performing the HRL process performed by the HRL unit 32 includes implementing a meta-controller 34 to determine goals and implementing a controller 35 to determine actions to achieve the goals, the goals including a specified throughput and delay for the steered traffic. In some embodiments, the controller 35 is configured to obtain an intrinsic reward based at least in part on an actual throughput and delay of the steered traffic. In some embodiments, the meta-controller 34 is configured to obtain an extrinsic reward based at least in part on a sum of intrinsic rewards. In some embodiments, performing the HRL process includes steering the traffic based at least in part on a comparison of a load balancing metric to a threshold.

FIG. 8 is a flowchart of another example process in an O-RAN node 25 for intelligent traffic steering in a radio access technology (RAT). One or more blocks described herein may be performed by one or more elements of O-RAN node 25 such as by processing circuitry 36 (including the HRL unit 32). The O-RAN node 25 such as via processing circuitry 36 is configured to perform a hierarchical reinforced learning, HRL, process configured to steer traffic between network nodes and WDs 22 using different radio access technologies, RATs, subject to constraints on delay and throughput (Block S136).

In some embodiments, performing the HRL process includes implementing a meta-controller 34 to determine goals and implementing a controller 35 to determine actions to achieve the goals, the goals including a specified throughput and delay for the steered traffic. In some embodiments, implementing the controller 35 includes obtaining an intrinsic reward based at least in part on an actual throughput and delay of the steered traffic. In some embodiments, a goal of the controller 35 is a threshold associated with a queue length of each type of RAT. In some embodiments, states of the controller 35 depend on at least one of a traffic type, a link quality between a network node and a WD 22 and a queue length. In some embodiments, implementing the meta-controller 34 includes obtaining an extrinsic reward based at least in part on a sum of intrinsic rewards. In some embodiments, states of the meta-controller 34 depend on at least one of a traffic type, a signal to interference plus noise ratio, SINR, measurement a queue length. In some embodiments, implementing the meta-controller 34 includes generating a policy based on states of the meta-controller 34. In some embodiments, implementing the controller 35 includes generating a policy based on a state of the meta-controller 34. In some embodiments, performing the HRL process includes steering the traffic based at least in part on a comparison of a load balancing metric to a threshold.

Having described the general process flow of arrangements of the disclosure and having provided examples of hardware and software arrangements for implementing the processes and functions of the disclosure, the sections below provide details and examples of arrangements for systems and methods for intelligent traffic steering in a radio access technology (RAT).

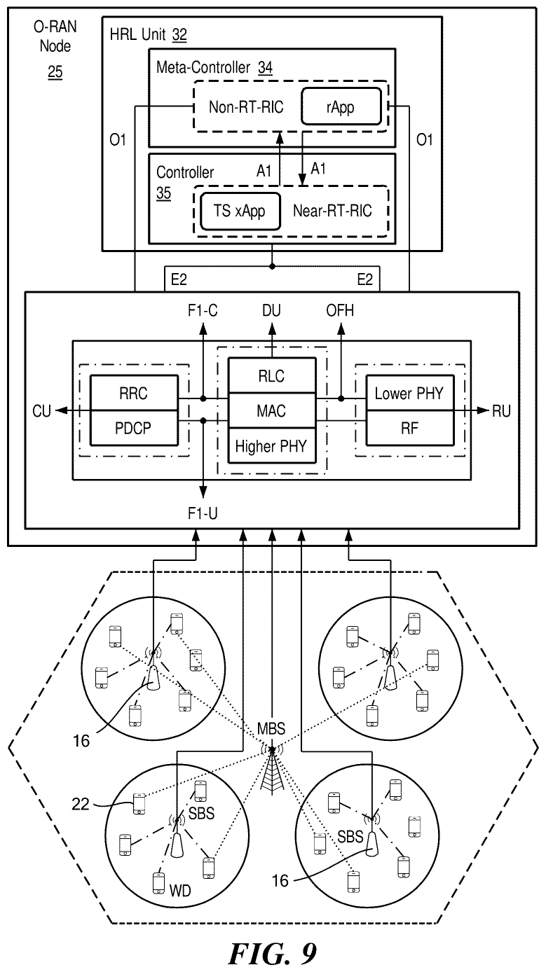

A multi-RAT network is considered where multiple users are connected with 5G and LTE RATs via DC. There are small cells having 5G NR network nodes 16 that may serve applications requiring high throughput and low latency. Small cells are within the range of a macro-cell that is facilitated by one LTE network node 16 (eNB). There are total Φ flows in the network, and each WD 22 in the network 10 has a traffic flow φ that may be either steered to an eNB or a gNB based on the decision of the HRL unit 32. An example of an O-RAN-based wireless system for 5G NSA mode is presented in FIG. 9.

There may be three control loops in the system. The first one is the non-RT control loop which is directly related to the non-RT-RIC of the meta-controller 34 with a latency much larger than is. This is where policies may be set and RAN analytics gathered. The near-RT-RIC of the controller 35 has a control loop larger than 10 ms and less than is time frame. In this time frame, the traffic steering xApp disclosed herein may operate and produce actions to perform flow admission to a RAT.

In some embodiments, the total downlink bandwidth is divided into multiple resource blocks. A resource block contains a set of 12 contiguous subcarriers as defined per 3GPP Technical Specifications. In some embodiments, consecutive resource blocks may be grouped to constitute a resource block group (RBG). In some embodiments, each RBG is allocated a certain transmission power by a network node. Based on a system model, each network node 16 may hold several transmission buffers corresponding to the number of users connected to it. Every transmission time interval (TTI), the downlink scheduler assigns resources to the users having pending data transmissions.

In some embodiments, a delay is considered as the summation of transmission and queueing delay which is as follows:

$${D}_{k , b} = {D}_{k , b}^{T} + {D}_{k , b}^{Q} , \qquad ( 1 )$$

where

$${D}_{k , b}^{T}$$

is the transmission delay experienced for a particular traffic type k and network node b, and

$${D}_{k , b}^{Q}$$

is the queueing delay experienced for a particular traffic type k at network node b for a user u.

To conduct traffic steering for different traffic types having variant QoS requirements for delay and throughput, two parameters may be defined. The first is the delay parameter which is calculated as the ratio of the defined QoS requirement for delay (D_{QoS}) and the actual delay (D_{k,b}) experienced in the system for a specific traffic type:

$${ϖ}_{k , b}^{D} = \frac{{D}_{QoS}}{{D}_{k , b}} . \qquad ( 2 )$$

Similarly, the throughput parameter is obtained as the ratio of the throughput achieved by the system running the disclosed algorithm and the minimum throughput required:

$${ϖ}_{k , b}^{T} = \frac{{T}_{k , b}}{{T}_{QoS}} , \qquad ( 3 )$$

where T_{QoS} is throughput requirement defined in the simulation for a specific traffic type and T_{k,b} is the actual throughput achieved.

In some embodiments, a goal is to improve system performance in terms of the delay and throughput. To represent such goal, a new variable may be defined. The variable combines the delay and throughput parameters that were presented in eq. (2) and (3). It is as follows:

$$P = {c}_{1} ( {ϖ}_{k , b}^{D} ) + {c}_{2} ( {ϖ}_{k , b}^{T} ) - H \qquad ( 4 )$$

where c₁ and c₂ are the weight factors and H is the handover penalty since excessive handover in the system would affect the system throughput. The network optimization problem addressed herein is associated with this variable P, and is as follows:

$$max {\sum }_{u ∈ U} {\sum }_{φ ∈ K} {\sum }_{b ∈ B} {P}_{u , φ , b} , \qquad ( 5 )$$

$$s . t . {\sum }_{( u , b ) ∈ L} {β}^{{φ}_{k}} \geq {β}^{φ} \qquad ∀ φ ∈ Φ ,$$

$${\sum }_{( u , b ) ∈ L} D ( u , b ) {v}_{u , b}^{φ} \leq {D}^{φ} \qquad ∀ φ ∈ Φ ,$$

where β^{φ}^{ₖ} is the required bitrate for a particular type of traffic k, and β^{φ} is the available bitrate. Also, D^{φ} represents the latency demand of flow D^{φ} and D(u, b) is the latency of link (u, b).

On one hand, steering the user traffic to the RAT that may best serve the QoS demands of that specific traffic type may significantly increase network performance. However, for long-term performance, the high load imposed on the network node 16 when the traffic load increases vastly may be considered. Therefore, to maximize the total objective, an intelligent mechanism is employed to perform load balancing to maintain a desired level of performance. The HRL algorithm implemented by the HRL unit 32 of the O-RAN node 25 may perform threshold-based load balancing in a dynamic manner.

In typical RL, the problem is defined as an MDP <S, A, T, R>, where S is the set of states, A is the set of actions, T is the transition probability (T:S×A×S) and R is the reward function. A standalone agent (which may include HRL unit 32) interacts with the environment (which includes the network nodes 16) to maximize the reward.

Compared with the traditional RL, the HRL unit 32 includes two controllers, a meta-controller 34, and a controller 35. The MDP for HRL is rewritten as <S, A, T, R, G>. G in the tuple indicates a set of goals. Based on the current state, s∈S, the meta-controller 34 is supposed to produce high level goals g∈G for the controller 35. Next, these goals are transformed for high-level policies. The controller 35 is responsible for choosing low-level actions a∈A based on the high-level policies and on the process of doing so, receives an intrinsic reward rᵢₙ. Finally, the meta-controller 34 may obtain an extrinsic reward rₑₓ from the environment and provide the controller 35 with a new goal, g′. HRL may provide more efficient learning because of the hierarchy introduced in the architecture. By dividing the sub-goals, HRL allows more efficient management of RAN functionalities.

To transform the problem formulated in eq. (5) into HRL notations, the following MDP is defined for the meta-controller 34 and the controller 35. Using the rApp in non-RT-RIC as the meta-controller 34 and the traffic steering xApp in near-RT-RIC as the controller 35, the following examples may be defined:
State: There may be three elements in the set of states, s_{sub}={T_{f}, L_{Q(SINR)}, q_{L}}. Here, T_{f} represents the traffic type. The second element of the set of states is the signal to interference plus noise ratio (SINR) measurements to represent the link quality between a network node 16 and WD 22: L_{Q(SINR)}={SINR_{eNB}, SINR_{gNB}}. As for the last element in state space, a queue length of both LTE and 5G NR RATs to represent load level may be used: q_{L}={q_{L(gNB)}, q_{L(eNB)}};
Action: Flow admission to the different RATs in a multi-RAT environment is considered in the action space which is defined as: {A_{L}, A_{NR}}. Here, flow admission to the LTE RAT is presented by A_{L} and 5G RAT by A_{NR};
Intrinsic reward: The intrinsic reward function for the controller 35 is same as eq. (5) and is as follows:

$${r}_{i n} = {c}_{1} ( {ϖ}_{k , b}^{D} ) + {c}_{2} ( {ϖ}_{k , b}^{T} ) - H \qquad ( 6 )$$

The meta-controller 34 is responsible for high level policies for the agent. MDP definitions for the meta-controller 34 may be stated as follows:
State: The states of the meta-controller 34 include the traffic type, SINR measurements, and queue length of each type of RAT: sₘₑₜₐ=T_{f}, L_{Q(SINR)}, q_{L};
Goal for the controller 35: Thresholds associated with the queue length may be considered as the goals for the controller 35. Therefore, G={g₁, g₂, . . . , gₙ}={Th₁, Th₂, . . . , Thₙ}. Transmission is steered to another RAT for load balancing based on this threshold;
Extrinsic reward: The meta-controller 34 is responsible for the overall performance of the whole system. Therefore, the extrinsic reward function is set for the meta-controller 34 as the objective of the problem formulation presented in eq. (5). The following equation is basically the summation of the intrinsic reward over τ steps:

$${r}_{ex , τ} = \frac{1}{n} {\sum }_{τ = 1}^{n} {r}_{i n , τ} \qquad ∀ ( u ) ∈ U , ∀ ( b ) ∈ B$$

The meta-controller 34 creates a policy over states observed from the network environment through the estimation of the

$${Q}_{N}^{M}$$

value function by maximizing the future rₑₓ. With the current goal and the state obtained from the meta-controller 34, the controller 35 in the Near-RT-RIC generates policy over actions via the

$${Q}_{N}^{S}$$

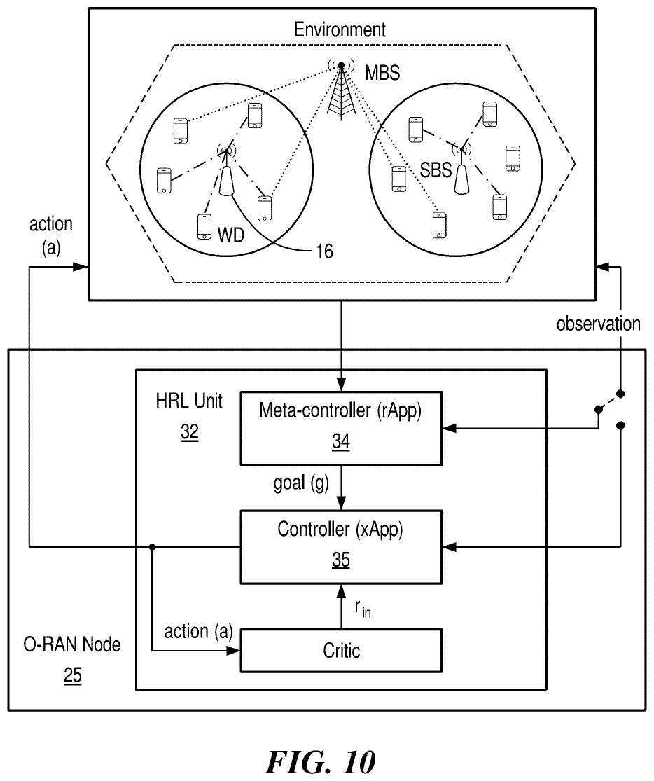

value function by maximizing the future rᵢₙ. If the episode ends or a goal is accomplished, termination of the controller 35 may be performed. The meta-controller 34 in the non-RT-RIC opts for a new goal after that and the whole process repeats. FIG. 10 summarizes the process.

The meta-controller 34 (rApp) in non-RT-RIC and the controller 35 (xApp) in near-RT-RIC may have separate DQNs inside.

$${Q}_{N}^{M}$$

of the meta-controller 34 may be updated by:

$${Q}_{M}^{N} ( {s}_{meta} , {g}_{meta} ) = {Q}_{M}^{O} ( {s}_{meta} , {g}_{meta} ) + α ( {r}_{ex} + γ {max}_{g} {Q}_{meta} ( {s}_{meta}^{′} , g ) - {Q}_{M}^{O} ( {s}_{meta} , {g}_{meta} ) ) , \qquad ( 8 )$$

where

$${s}_{meta}^{′}$$

is the next state, α is the learning rate, and γ is the discount factor. The new and old values are represented as

$${Q}_{M}^{N} and {Q}_{M}^{O} .$$

This means the accumulated reward is brought by state-goal pair (sₘₑₜₐ, gₘₑₜₐ). Next, the ε-greedy policy may be used for goal selection, which may balance the exploration and exploitation of goals so that long term rewards are achieved:

$$π ( {s}_{meta} ) = \{ \begin{matrix}random goal selection , & rand \leq ε \\ arg {max}_{g} Q ( {s}_{meta} , g ) , & rand > ε ,\end{matrix} \qquad ( 9 )$$

where rand is a random number generated between 0 to 1 and ε is less than 1.

The Q-value of the controller 35 is updated in a similar fashion like eq. (9):

$${Q}_{S}^{N} ( {s}_{sub} , {g}_{m eta} , {a}_{s u b} ) = {Q}_{S}^{O} ( {s}_{sub} , {g}_{m eta} , {a}_{sub} ) + α ( {r}_{i n} + γ {max}_{a} {Q}_{s u b} ( {s}_{sub}^{′} , {g}_{meta}^{′} , a ) - {Q}_{S}^{O} ( {s}_{sub} , {g}_{m eta} , {a}_{s u b} ) ) , \qquad ( 10 )$$

where

$${s}_{s u b}^{′}$$

is the next state, the next goal produced by the meta-controller 34 is

$${g}_{meta}^{′} .$$

The old and new Q-values are represented by

$${Q}_{S}^{N} and {Q}_{S}^{O} ,$$

respectively. As before, an ε-greedy policy may be used for controller's action selection.

$$π ( {s}_{sub} ) = \{ \begin{matrix}random action selection , & rand \leq ε \\ arg {max}_{g} Q ( {s}_{sub} , {g}_{meta} , a ) , & rand > ε ,\end{matrix}$$

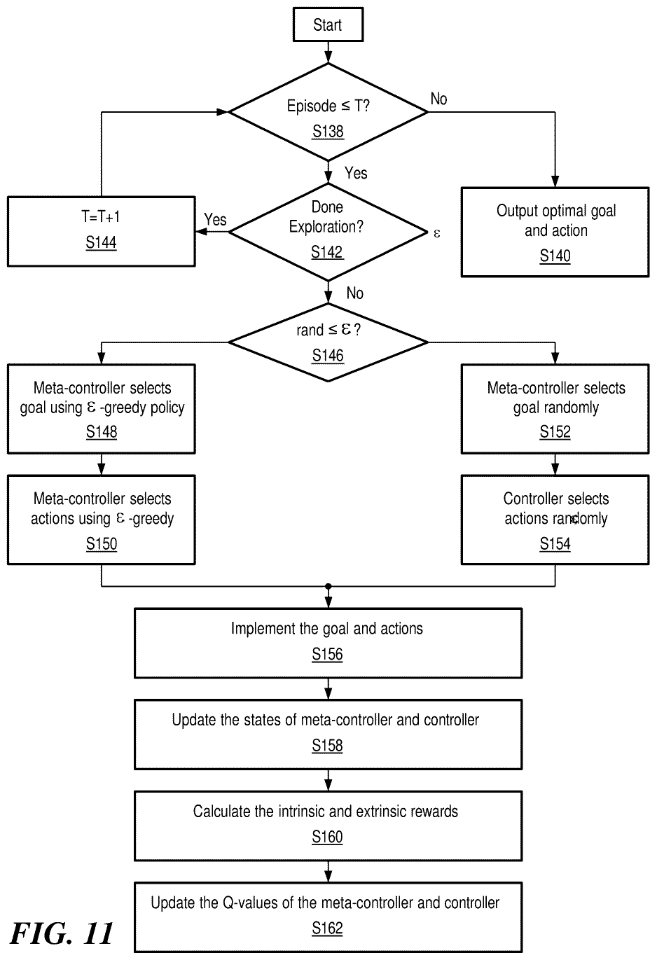

A flow chart of an example process is shown in FIG. 11.

The process begins by Initializing all the network and HRL parameters. If an episode is not less than a value T, (S138), then an optimal goal and action are output (S140).

When exploration is done (S1420, the value of T is incremented (S144) and the process continues at S138. Depending on a value of a random number (S146) a goal and action are selected using either an epsilon-greedy policy (S148, S150) random goal and action selection are performed (S152, S154). This may be implemented by load balancing threshold selection by the meta-controller 34 in the non-RT-RIC level.

Selection of actions may be implemented by a traffic steering decision by the controller 35 in the near-RT-RIC level.

Next goal and actions are implemented (S156), and states of the meta-controller 34 and controller 35 are updated (S158). Intrinsic and extrinsic rewards are calculated (S160); and the Q-value of the meta-controller 34 and the controller 35 are updated.

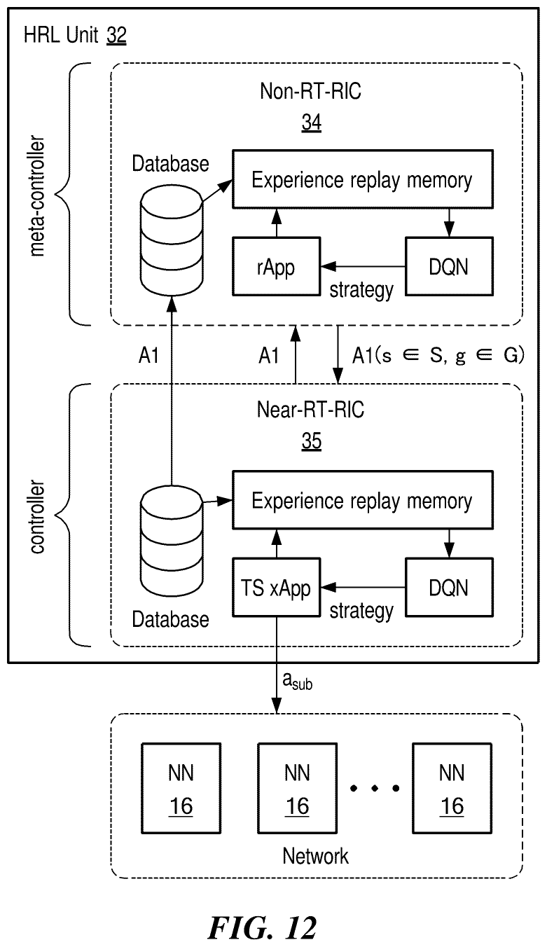

In an O-RAN hierarchy of some embodiments, the HRL-model takes decisions at two timescales. Meta-controller 34 on a top level module (non-RT-RIC) takes in the state perceived by the agent from the network environment and picks a new load balancing threshold as a goal. On the other hand, the controller 35 which is embedded in near-RT-RIC, uses both the state and the chosen goal to select the actions until the episode is terminated. The models may be trained using a stochastic gradient descent at different temporal scales to optimize expected future intrinsic reward for the xApp-based controller 35 and extrinsic reward for the rApp-based meta-controller 34. The process is summarized in the example diagram of FIG. 12.

Some embodiments may include one or more of the following:

Embodiment A1. An O-RAN node configured to communicate with a plurality of network nodes and wireless devices (WDs), the O-RAN node configured to, and/or comprising a radio interface and/or comprising processing circuitry configured to:
perform a hierarchical reinforced learning, HRL, process configured to steer traffic between network nodes and WDs using different radio access technologies, RATs, according to a traffic type and a link quality subject to constraints on delay and throughput.

Embodiment A2. The O-RAN node of Embodiment A1, wherein performing the HRL process includes implementing a meta-controller to determine goals and implementing a controller to determine actions to achieve the goals, the goals including a specified throughput and delay for the steered traffic.

Embodiment A3. The O-RAN node of Embodiment A2, wherein the controller is configured to obtain an intrinsic reward based at least in part on an actual throughput and delay of the steered traffic.

Embodiment A4. The O-RAN node of any of Embodiments A2 and A3, wherein the meta-controller is configured to obtain an extrinsic reward based at least in part on a sum of intrinsic rewards.

Embodiment A5. The O-RAN node of any of Embodiments A1-A4, wherein performing the HRL process includes steering the traffic based at least in part on a comparison of a load balancing metric to a threshold.

Embodiment B1. A method implemented in an O-RAN node configured to communicate with a plurality of network nodes and wireless devices (WDs), the method comprising:
performing a hierarchical reinforced learning, HRL, process configured to steer traffic between network nodes and WDs using different radio access technologies, RATs, according to a traffic type and a link quality subject to constraints on delay and throughput.

Embodiment B2. The method of Embodiment B1, wherein performing the HRL process includes implementing a meta-controller to determine goals and implementing a controller to determine actions to achieve the goals, the goals including a specified throughput and delay for the steered traffic.

Embodiment B3. The method of Embodiment B2, wherein the controller is configured to obtain an intrinsic reward based at least in part on an actual throughput and delay of the steered traffic.

Embodiment B4. The method of any of Embodiments B2 and B3, wherein the meta-controller is configured to obtain an extrinsic reward based at least in part on a sum of intrinsic rewards.

Embodiment B5. The method of any of Embodiments B1-B4, wherein performing the HRL process includes steering the traffic based at least in part on a comparison of a load balancing metric to a threshold.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviations | Explanations |
|---|---|
| 5G NR | 5G new radio |
| DQN | Deep-Q-network |
| DQN | Deep Q-learning |
| 5G NR | Fifth generation new radio |
| DC | Dual connectivity |
| RAN | Radio access network |
| O-RAN | Open RAN |
| RIC | RAN intelligent controller |
| Near-RT-RIC | Near-real time-RIC |
| Non-RT-RIC | Non-real time-RIC |
| DRL | Deep reinforcement learning |
| eNB | Evolved node B |
| gNB | 5G NR network node |
| KPI | Key performance indicators |
| LTE | Long-term evolution |
| Multi-RAT | Multiple radio access technology |
| network node | Base station |
| NSA | Non-stand-alone |
| QoS | Quality of service |
| RBG | Resource block group |
| MDP | Markov decision process |
| 3GPP | 3^{rd} generation partnership project |
| HRL | Hierarchical reinforcement learning |
| AI | Artificial intelligence |
| ML | Machine learning |
| RL | Reinforcement Learning |
| RAT | Radio access technology |
| RBG | Resource block group |
| TTI | Transmission time interval |
| UE | User equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An Open Radio Access Network, O-RAN, node configured to communicate with a plurality of network nodes and wireless devices, WDs, the O-RAN node configured to:
perform a hierarchical reinforced learning, HRL, process configured to steer traffic between network nodes and WDs using different radio access technologies, RATs, subject to constraints on delay and throughput.

2. The O-RAN node of claim 1, wherein performing the HRL process includes implementing a meta-controller to determine goals and implementing a controller to determine actions to achieve the goals, the goals including a specified throughput and delay for the steered traffic.

3. The O-RAN node of claim 2, wherein the controller is configured to obtain an intrinsic reward based at least in part on an actual throughput and delay of the steered traffic.

4. The O-RAN node of claim 2, wherein a goal of the controller is a threshold associated with a queue length of each type of RAT.

5. The O-RAN node of claim 2, wherein states of the controller depend on at least one of a traffic type, a link quality between a network node and a WD and a queue length.

6. The O-RAN node of claim 2, wherein the meta-controller is configured to obtain an extrinsic reward based at least in part on a sum of intrinsic rewards.

7. The O-RAN node of claim 2, wherein states of the meta-controller depend on at least one of a traffic type, a signal to interference plus noise ratio, SINR, measurement a queue length.

8. The O-RAN node of claim 2, wherein the meta-controller is configured to generate a policy based at least in part on states of the meta-controller.

9. The O-RAN node of claim 2, wherein the controller is configured to generate a policy based at least in part on a state of the meta-controller.

10. The O-RAN node of any of claim 1, wherein performing the HRL process includes steering the traffic based at least in part on a comparison of a load balancing metric to a threshold.

11. A method in an O-RAN node configured to communicate with a plurality of network nodes and wireless devices, WDs, the method comprising:
performing a hierarchical reinforced learning, HRL, process configured to steer traffic between network nodes and WDs using different radio access technologies, RATs, subject to constraints on delay and throughput.

12. The method of claim 11, wherein performing the HRL process includes implementing a meta-controller to determine goals and implementing a controller to determine actions to achieve the goals, the goals including a specified throughput and delay for the steered traffic.

13. The method of claim 12, wherein implementing the controller includes obtaining an intrinsic reward based at least in part on an actual throughput and delay of the steered traffic.

14. The method of claim 12, wherein a goal of the controller is a threshold associated with a queue length of each type of RAT.

15. The method of claim 12, wherein states of the controller depend on at least one of a traffic type, a link quality between a network node and a WD and a queue length.

16. The method of claim 12, wherein implementing the meta-controller includes obtaining an extrinsic reward based at least in part on a sum of intrinsic rewards.

17. The method of claim 12, wherein states of the meta-controller depend on at least one of a traffic type, a signal to interference plus noise ratio, SINR, measurement a queue length.

18. The method of claim 12, wherein implementing the meta-controller includes generating a policy based at least in part on states of the meta-controller.

19. The method of claim 12, wherein implementing the controller includes generating a policy based at least in part on a state of the meta-controller.

20. The method of claim 11, wherein performing the HRL process includes steering the traffic based at least in part on a comparison of a load balancing metric to a threshold.
